(19) United States
(12) Patent Application Publication
(10) Pub. No.: US 2008/0164706 A1
(43) Pub. Date: Jul. 10, 2008

(54) Intrinsically Safe Battery Lifting Device

(75) Inventors: David Jones, Grovetown, GA (US); Walton R. Jeffcoat, Augusta, GA (US)

Correspondence Address: HARNESS, DICKEY & PIERCE, P.L.C., P.O. BOX 828, BLOOMFIELD HILLS, MI, 48303, US

(73) Assignee: TEXTRON INC., Providence, RI (US)

(21) Appl. No.: 11/619,825

(22) Filed: Jan. 4, 2007

(51) Int. Cl. B66C 1/54

(52) U.S. Cl. 294/97

(57) ABSTRACT

In various embodiments, a battery lifting device is provided that includes an expandable retention subassembly, a shaft and a handle. The expandable retention subassembly is adapted to engage lifting tabs of a battery to be lifted and the shaft is pivotally coupled to the retention subassembly. The handle is connected to the shaft such that a lifting force applied to the handle utilizes the weight of the battery to expand the retention subassembly. Expansion of the retention subassembly, via the weight of the battery as the battery is lifted, firmly engages the retention subassembly with the battery lifting tabs such that the battery will not become dislodged or disconnected until the lifting force is removed.

### FIELD

The present teachings relate to a device, or mechanism, for lifting and moving vehicle batteries for installation, removal and storage.

### BACKGROUND

The statements in this section merely provide background information related to the present disclosure and may not constitute prior art

Known automobiles, trucks, boats, trains, aircraft and light-weight utility vehicles, such as small cargo/maintenance vehicles, shuttle vehicles or golf cars, typically utilize one or more batteries to provide an electrical power source for operation of the vehicle and various vehicle systems. For example, most all automobiles and trucks utilize one or more 12 volt lead-acid batteries to provide electrical power for operating ignition, lighting and various accessory systems. Additionally, most electrically powered utility vehicles employ one or more 6 volt and/or 12 volt lead-acid batteries that deliver electrical power used to drive electric motors that provide motive forces for operation of the vehicle.

Such batteries can typically weigh between 40 and 70 pounds, or more, making them very cumbersome, difficult and laborious to lift and move during installation, removal and storage processes.

### SUMMARY

A battery lifting device is provided. In various embodiments, the battery lifting device includes an expandable retention subassembly, a shaft and a handle. The expandable retention subassembly is adapted to engage lifting tabs of a battery to be lifted and the shaft is pivotally coupled to the retention subassembly. The handle is connected to the shaft such that a lifting force applied to the handle utilizes the weight of the battery to expand the retention subassembly. Expansion of the retention subassembly, via the weight of the battery as the battery is lifted, firmly engages the retention subassembly with the battery lifting tabs such that the battery will not become dislodged or disconnected until the lifting force is removed.

Further areas of applicability of the present teachings will become apparent from the description provided herein. It should be understood that the description and specific examples are intended for purposes of illustration only and are not intended to limit the scope of the present teachings.

### DRAWINGS

The drawings described herein are for illustration purposes only and are not intended to limit the scope of the present teachings in any way.

FIG. 1 is a side view of a battery lifting device, in accordance with various embodiments of the present disclosure.

FIG. 2 is a side view of the battery lifting device shown in FIG. 1 engaged with lifting tabs of a battery to be lifted, in accordance with various embodiments of the present disclosure.

FIG. 3 is a front view of the battery lifting device shown in FIG. 1 illustrating an expandable retention subassembly of the battery lifting device including a pair of A-frame linkages, in accordance with various embodiments of the present disclosure.

FIG. 4 is a front view of the battery lifting device shown in FIG. 3 engaged with the lifting tabs of the battery to be lifted, in accordance with various embodiments of the present disclosure.

FIG. 5 is a front view of the battery lifting device shown in FIG. 1 illustrating an expandable retention subassembly of the battery lifting device including a single A-frame linkage, in accordance with various embodiments of the present disclosure.

FIG. 6 is a front view of the battery lifting device shown in FIG. 5 engaged with the lifting tabs of the battery to be lifted, in accordance with various embodiments of the present disclosure.

FIG. 7 is a detail view a portion of an expandable retention subassembly of the battery lifting device shown in FIG. 1, in accordance with various embodiments of the present disclosure.

### DETAILED DESCRIPTION

The following description is merely exemplary in nature and is in no way intended to limit the present teachings, application, or uses. Throughout this specification, like reference numerals will be used to refer to like elements.

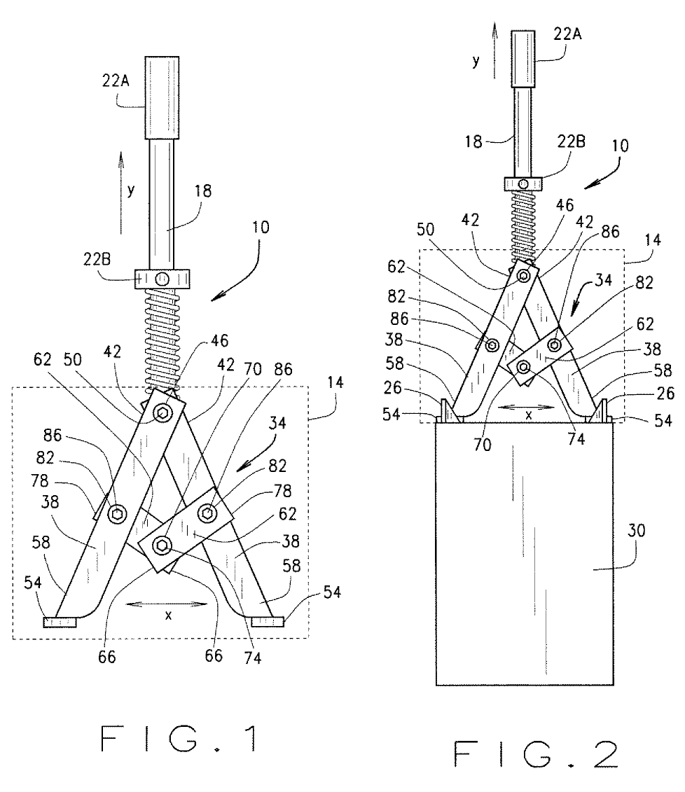

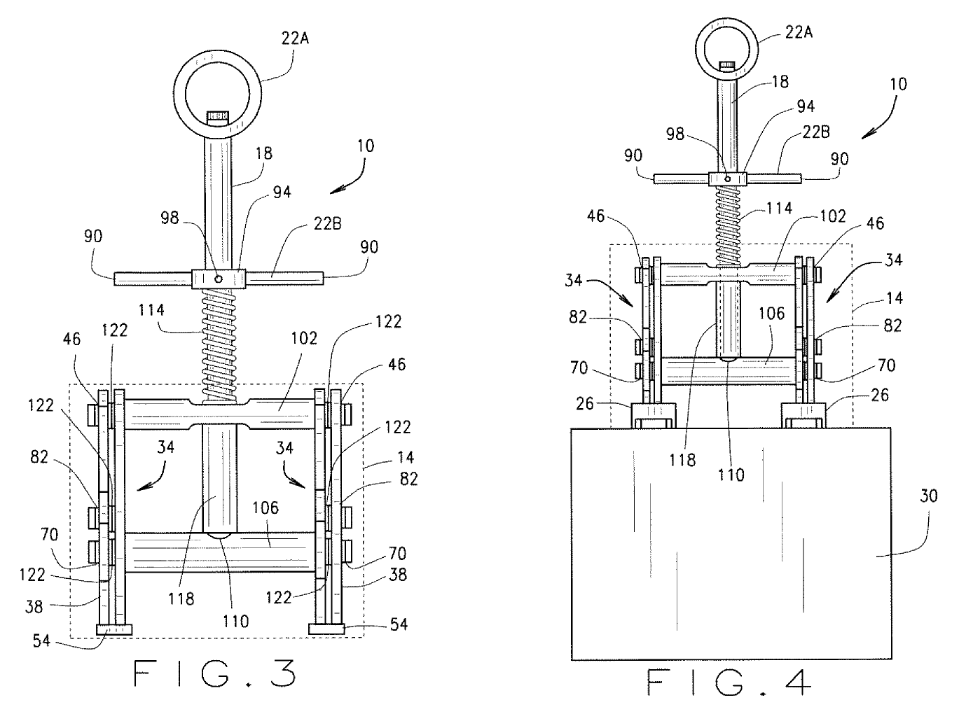

Referring to FIGS. 1 and 2, in accordance with various embodiments, a battery lifting device 10 is provided that generally includes an expandable retention subassembly 14, a shaft 18 and at least one handle 22. As described below, the handle 22 can comprise a lift receptacle 22A and/or a lift bar 22B. The expandable retention subassembly 14 is adapted to engage two or more lifting tabs 26 of a battery 30 to be lifted and the shaft 18 is pivotally coupled to the retention subassembly 14. The handle 22, i.e., the lift receptacle 22A and/or the lift bar 22B, is connected to the shaft 18 such that a lifting force applied to the handle 22 in the Y direction utilizes the weight of the battery 30 to expand the retention subassembly in the X directions. As described in detail below, expansion of the retention subassembly 14, via the weight of the battery 30 as the battery 30 is lifted, firmly engages the retention subassembly 14 with the battery lifting tabs 26 such that the battery 30 will not become dislodged or disconnected from the lifting device 10 until the lifting force is removed.

The retention subassembly 14 includes one or more A-frame linkage 34, as illustrated and described below with regard to FIGS. 3-6. Each A-frame linkage includes a pair of legs 38 having proximal ends 42 pivotally coupled at vertex joint 46. The vertex joint 46 generally includes a pin, rivet, nut and bolt fastener, or any other suitable pivot joint fastener 50 inserted through apertures (not shown, but readily understood by one skilled in the art) in the proximal ends 42 and fastened to pivotally couple the A-frame legs 42 at their proximal ends 42. Each A-frame leg 38 additionally includes a tab catch 54 at a distal end 58 of the respective leg 38. Each tab catch 54 is structured to engage and removably couple with a respective battery lift tab 26 such that when the lifting force is applied to the shaft 18 the battery 30 will be suspended from the lifting device 10 via the inter-coupling of the lift tabs 26 with the tab catches 54.

The lift tabs 26 and the tab catches 54 can be any cooperatively mating components suitable for interconnecting and supporting the suspended weight of the battery 30. For example, the lift tabs 26 can comprise stirrups, loops or hooks connected to or integrally formed with the battery 30 and the tab catches 54 can comprise pins, posts, hooks or feet extending from the A-frame leg distal ends 58. Accordingly, the tab catches 54, e.g., the pins, posts, hooks or feet extending from the A-frame leg distal ends 58, interconnect with the respective lift tabs 26, e.g., the stirrups, loops or hooks as the A-frame legs distal ends 58 expand in the X directions when the lifting force is applied to the shaft, as described further below.

Each A-frame 34 additionally includes a pair of cross-arms 62 having proximal ends 66 pivotally linked at a lift joint 70. The lift joint 46 generally includes a pin, rivet, nut and bolt fastener, or any other suitable pivot joint fastener 74 inserted through apertures (not shown, but readily understood by one skilled in the art) in the proximal ends 66 and fastened to pivotally couple the A-frame cross-arms 62 at their proximal ends 66. Each cross-arm 62 additionally includes a distal end 78 pivotally coupled to a respective one of the A-frame legs 38 at a respective lever joint 82. Each lever joint 82 generally includes a pin, rivet, nut and bolt fastener, or any other suitable pivot joint fastener 86. The lever joint pivot fasteners 86 are inserted through apertures (not shown, but readily understood by one skilled in the art) in the cross-arm distal ends 78 and respective A-frame legs 38, and fastened to pivotally couple the A-frame cross-arms 62 at their distal ends 78 to a mid-portion of the respective A-frame leg 38.

Referring now to FIGS. 3-6, as described above, in various embodiments, the handle 22 can comprise a lift receptacle 22A and/or a lift bar 22B. The lift receptacle 22A can be any suitable receptacle structured to receive a hooking device of a battery hoist (not shown) used to provide the lifting force. For example, the lift receptacle 22A can be an eyelet, loop or hook mounted, coupled, or affixed to a top portion of the shaft 18. Thus, the hoist hooking device, e.g., a hook, gaff, clasp or clamp, can be interconnected with the lift receptacle so that the battery hoist can be utilized to apply the lifting force, which in turn, interconnects the A-frame tab catches 54 with the battery lift tabs 26 to lift the battery 30 from a present location. The battery 30 is then suspended by the hoist and able to be moved and relocated or repositioned, e.g., installed into or removed from an electric vehicle battery bank.

In various embodiments, the lift bar 22B includes a pair opposing arms 90 that extend outwardly from a lift bar hub 94 on opposing side of the shaft 90. The hub 94 is coupled to the shaft 18 such that a lifting force applied to one or both of the arms 90 will apply the lifting force to the shaft 18. In various implementations, the lift bar hub 94 includes a set screw 98 that can be loosened and tightened to position the lift bar 22B at any desirable location along the shaft 18. Thus, the lift bar arms can be grasped by a person or hoist to apply the lifting force to the shaft 18, which in turn, interconnects the A-frame tab catches 54 with the battery lift tabs 26 to lift the battery 30 from a present location. The battery 30 can then be moved and relocated or repositioned, e.g., installed into or removed from an electric vehicle battery bank.

Each expandable retention subassembly 14 additionally includes an upper cross-bar 102 rotationally connected to the vertex joint 46 of the one or more A-frames 34. Furthermore, in various embodiments, each expandable retention subassembly 14 additionally includes a lower cross-bar 106 rotationally connected to the lift joint 70 of the one or more A-frames 34.

Referring now particularly to FIGS. 3 and 4, in various embodiments, the expandable retention subassembly 14 can include a pair of A-frame linkages 34. In such embodiments, the cross-bar 102 is rotationally connected at opposing ends to the vertex joints 46 of the respective A-frame linkages 34. Similarly, the lower cross-bar 106 is rotationally connected at opposing end to the lift joints 70 of the respective A-frame linkages 34.

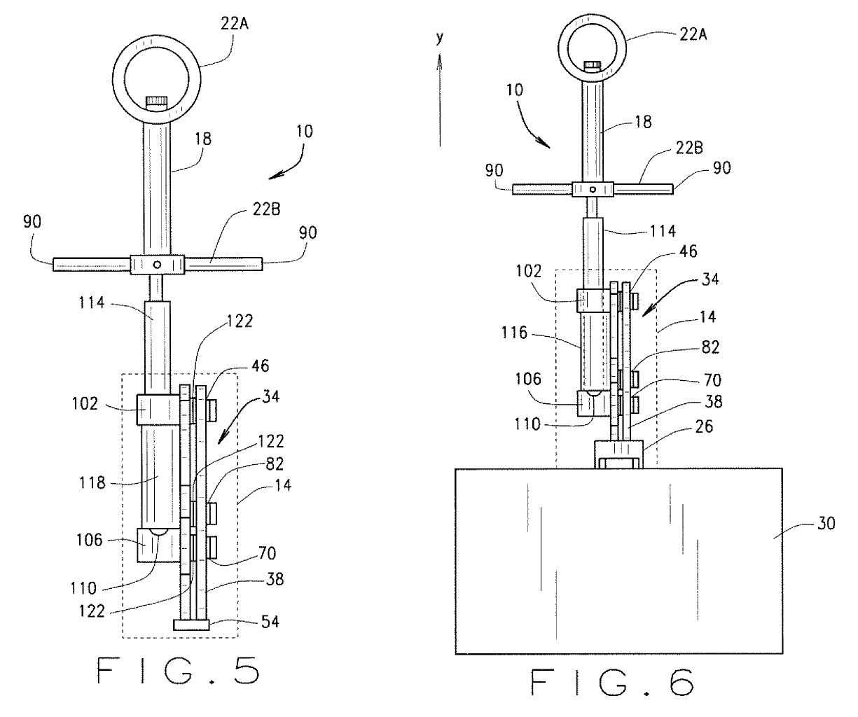

Referring now particularly to FIGS. 5 and 6, in various embodiments, the expandable retention subassembly 14 can include a single A-frame linkage 34. In such embodiments, the cross-bar 102 is rotationally connected at one end to the vertex joint 46 of the respective A-frame linkage 34. Similarly, the lower cross-bar 106 is rotationally connected at one end to the lift joint 70 of the respective A-frame linkage 34.

Referring again to FIGS. 3-6, the shaft 18 extends through an aperture (not shown, but readily understood by one skilled in the art) in the upper cross-bar 102 and is connected at a distal end 110 to the lower cross-bar 106. The shaft 18 can be connected to the lower cross-bar 106 in any suitable manner, for example the shaft 18 can be welded to, bolted to, or threaded into, the lower cross-bar 106. Therefore, when the lifting force is applied to the shaft 18, e.g., via the lift receptacle 22A or lift bar 22B, the shaft 18 slides within the aperture in the upper cross-bar 102 and exerts the lifting force on the lower cross-bar 106. The lifting force exerted on the lower cross-bar 106 is then transferred to the lift joint(s) 70 of the respective A-frame linkage(s) 34. As illustrated in FIGS. 1 and 2, each A-frame linkage 34 is assembled such that the cross-arms 62 are pivotally coupled at the lift joint 70 to have a V-shape with the vertex of the cross-arms 62 pointing away from the vertex joint 46 of the A-frame legs 38. Accordingly, when the lifting force is transferred to the lift joint(s) 70, the vertex of the cross-arms 62 is pulled in the Y direction toward the vertex joint(s) 46. Pulling the lift joint(s) 70 in the Y direction causes expansion forces in the X directions to be applied to the respective A-frame legs 38 at the lever joints 82. Since the proximal ends 42 of the legs 38 of each A-frame linkage are pivotally connected at the respective vertex joint 46, the expansion forces cause the distal ends 58 of the A-frame legs 38 to expand in the X directions.

More particularly, when the tab catches 54 are engaged with the battery lifting tabs 26 and the lifting force is applied to the shaft 18, the resulting expansion forces causes the tab catches 54 to firmly engage the lifting tabs 26 until the lifting force is removed. Even more particularly, once the battery 30 is lifted and is suspended from the lifting device 10, it is the weight of the battery 30 that maintains the lifting force on the shaft 18 and the resulting expansion forces on the A-frame legs 38. Thus, the weight of the battery 30 maintains engagement of the tab catches 54 with the lifting tabs 26 such that the battery can not be dislodged or disconnected from the lifting device 10 until the battery 30 is relocated and the lifting force removed.

In various embodiments, the battery lifting device 10 additionally includes a biasing device 114 that is cooperatively operable with the shaft 18. The biasing device 114 applies a preliminary expansion force to the A-frame legs 38, thereby initially engaging the tab catches 54 with the battery lifting tabs 26 prior to the lifting force being applied to the shaft 18. More specifically, the biasing device is cooperatively operable with the shaft 18 and located between upper cross-bar 102 and the lift bar hub 94, or in the absence of the lift bar 22B a collar, similar to the hub 94, coupled to the shaft 18. The biasing device 114 exerts an equal and opposite force on the hub 94 (or collar) and the upper cross-bar. Thus, relative to the upper cross-bar, the hub 94 (or collar), and therefore the shaft 18, is pushed in the Y direction simulating a lifting force. Accordingly, the distal ends 58 of the A-frame legs 38 are expanded and the tab catches 54 are engaged with the battery lifting tabs 26 prior to the lifting force being applied to the shaft 18.

Referring particularly to FIGS. 3 and 4, in various embodiments, the biasing device 114 can be a spring positioned around the shaft 18 between the hub 94 (or collar) and the upper cross-bar 102.

Referring particularly to FIGS. 5 and 6, in various embodiments, the biasing device 114 can be a pneumatic or hydraulic piston assembly integrally formed with the shaft 18 between the hub 94 (or collar) and the upper cross-bar 102.

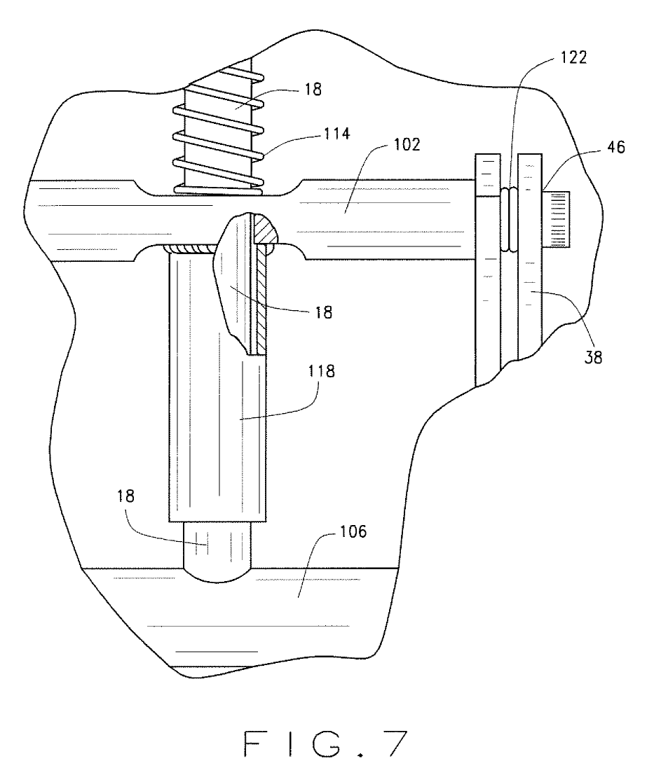

Referring to FIGS. 3-6 and 7, in various embodiments, the battery lifting device additionally includes a stop tube 118 positioned around a lower portion of the shaft 18 between the upper and lower cross-bars 102 and 106. The shaft 18 freely moves within the stop tube 118. The stop tube 118 is affixed to the upper cross-bar 102 and free from the lower cross-bar 106. For example, the stop tube 118 can be welded to, soldered to, threaded into, or integrally formed with, the upper cross-bar 102. Thus, as the upper cross-bar 102 moves away from the lower cross-bar 106, the stop tube 118 will be moved away from, and out of contact with, the lower cross-bar 106. Conversely, as the upper cross-bar 102 moves toward the lower cross-bar 106, the stop tube 118 will also be moved toward, and in contact with, the lower cross-bar 106, thereby limiting how short the distance between the upper and lower cross-bars 102 and 106 can be.

As described above, when the lifting force is applied to the shaft 18, the lift joint 70 is moved toward the vertex joint 46. Therefore, when the lifting force is applied to the shaft 18, the lower cross-bar 106 is moved toward the upper cross-bar 102. Accordingly, the stop tube 118 limits the distance the lower cross-bar 106 can travel toward the upper cross-bar 102 when the lifting force is applied to the shaft 18 and the battery 30 is lifted and suspended. More particularly, since the stop tube 118 limits the distance the lower cross-bar 106 can travel toward the upper cross-bar 102, the stop tube 118 limits the distance the tab catches 54 can travel in the X directions when the lifting force is applied to the shaft 118. Therefore, the weight of the battery 30 can not produce excessive expansion forces, described above, on the A-frame legs 38 that could damage or break the battery lift tabs 26 and create a potentially dangerous situation should the lift tabs 26 break while the battery 30 is being lifted, suspended and/or moved.

Additionally, in various embodiments, the vertex joint 46, the lift joint 70 and the lever joints 82 of each A-frame linkage 34 include a dielectric bushing and washer assembly 122. The dielectric bushing and washing assemblies 122 are fabricated from an electrically non-conductive, i.e., dielectric, material, such as plastic, nylon, silicone or rubber. The dielectric bushing and washer assemblies 122 are located within each vertex, lift and lever joint 46, 70 and 82 to electrically isolate all components of the expandable retention subassembly 14 from each other. That is, the dielectric bushing and washer assemblies 122 electrically isolate each of the A-frame legs 38 from each other and from the cross-arms 62, which are also electrically isolated from each other by the dielectric bushing and washer assemblies 122. Furthermore, in the embodiments that include a pair of A-frame linkages 34, the dielectric bushing and washer assemblies 122 electrically isolate the A-frame linkages 34 from the upper and lower cross-bars 102 and 106. Therefore, the A-frame linkages 34 are electrically isolating them from each other. Further yet, the dielectric bushing and washer assemblies 122 electrically isolate the shaft 18 and the handle 22, i.e., the lift receptacle 22A and/or the lift bar 22B, from all other components of the battery lifting device 10. Thus, the dielectric bushing and washer assemblies 122 provide protection from the danger of shorting the electrical terminals of the battery 30 that could damage the battery 30 and/or harm a person operating the battery lifting device 10.

The description herein is merely exemplary in nature and, thus, variations that do not depart from the gist of that which is described are intended to be within the scope of the teachings. Such variations are not to be regarded as a departure from the spirit and scope of the teachings.

What is claimed is:

1. A battery lifting device comprising
an expandable retention subassembly adapted to engage lifting tabs of a battery to be lifted;
a shaft pivotally coupled to the retention subassembly; and
a handle connected to the shaft such that a lifting force applied to the handle utilizes the weight of the battery to expand the retention subassembly and engage the retention subassembly with the battery lifting tabs until the lifting force is removed.

2. The device of claim 1, wherein the device further comprises a biasing device cooperatively operable with the shaft.

3. The device of claim 2, wherein the biasing device comprises a spring positioned around the shaft.

4. The device of claim 2, wherein the biasing device is one of a pneumatic and a hydraulic piston integrally formed with the shaft.

5. The device of claim 1, wherein the retention subassembly comprises at least one A-frame linkage, each A-frame linkage including:
a pair of legs having proximal ends pivotally coupled at vertex joint, and distal ends, each distal end including a tab catch; and
a pair of cross-arms having proximal ends pivotally linked at a lift joint, and distal ends pivotally coupled to a respective one of the legs at a respective lever joint.

6. The device of claim 5, wherein each of the vertex joint, the lift joint and the lever joints include a dielectric bushing and washer assembly.

7. The device of claim 5, wherein the shaft is pivotally joined with the cross-arms at the lift joint.

8. The device of claim 1, wherein the device further comprises a stop tube positioned around the shaft.

9. The device of claim 1, wherein the handle comprises a lift receptacle structured to receive a hooking device of a battery hoist.

10. The device of claim 1, wherein the handle comprises a lift bar having opposing arms that extend outwardly from opposing side of the shaft.

11. A battery lifting device comprising:
an expandable retention subassembly including a pair of A-frame linkages, each A-frame linkage comprising a pair of legs having proximal ends pivotally coupled at a vertex joint, and distal ends including a tab catch for engaging a respective one of a plurality of battery lifting tabs of a battery to be lifted;
a shaft pivotally coupled to the retention subassembly; and
a handle connected to the shaft such that a lifting force applied to the handle utilizes the weight of the battery to exert an expansion force on the A-frame linkages to engage the tab catches with the battery lifting tabs until the lifting force is removed.

12. The device of claim 11, wherein each A-frame linkage further includes a pair of cross-arms having proximal ends pivotally linked at a lift joint, and distal ends pivotally coupled to a respective one of the legs at a respective lever joint.

13. The device of claim 12, wherein each of the vertex joint, the lift joint and the lever joints include a dielectric bushing and washer assembly to electrically isolate each of the legs, and the cross-arms from each other.

14. The device of claim 12, wherein the device further comprises:
an upper cross-bar rotationally connected at opposing ends to the vertex joints of the A-frame linkages; and
a lower cross-bar rotationally connected at opposing end to the lift joints of the A-frame linkages.

15. The device of claim 14, wherein the shaft extends through an aperture in the upper cross-bar and is connected at a distal end to the lower cross-bar such that when the tab catches are engaged with the battery lifting tabs a lifting force applied to the shaft causes the lower cross-bar to transfer the lifting force to the lift joints, which in turn causes the distal ends of the cross-arms to apply an expansion force to the legs that expands the A-frame linkages, thereby firmly engaging the tab catches with battery lifting tabs until the lifting force is removed.

16. The device of claim 14, wherein the device further comprises a stop tube positioned around the shaft between the upper and lower cross-bars to limit expansion of the A-frame linkages when the lifting force is applied.

17. The device of claim 14, wherein the device further comprises a biasing device cooperative with the shaft between the upper cross-bar and the handle to apply a preliminary expansion force on the A-frame linkages to initially engage the retention subassembly with the lifting tabs prior to application of the lifting force.

18. The device of claim 17, wherein the biasing device comprises one of a spring positioned around the shaft, a pneumatic piston integrally formed with the shaft and a hydraulic piston integrally formed with the shaft.

19. The device of claim 11, wherein the handle comprises at least one of a lift receptacle structured to receive a hooking device of a battery hoist to apply the lifting force to the shaft, and a lift bar having opposing arms that extend outwardly from opposing side of the shaft such that the lift bar arms can be manually grasped to apply lifting force to the shaft.

20. A battery lifting device comprising:
an expandable retention subassembly comprising at least one A-frame linkage including:
a pair of legs having proximal ends pivotally coupled at vertex joint, and distal ends, each distal end including a tab catch for engaging a respective one of a plurality of battery lifting tabs of a battery to be lifted; and
a pair of cross-arms having proximal ends pivotally linked at a lift joint, and distal ends pivotally coupled to a respective one of
the legs at a respective lever joint.
a shaft pivotally joined with the cross-arms at the lift joint; and
a handle connected to the shaft such that a lifting force applied to the handle utilizes the weight of the battery to expand the retention subassembly and firmly maintain engagement of the retention subassembly with the battery lifting tabs until the lifting force is removed.

21. The device of claim 20, wherein the device further comprises a biasing device cooperative with the shaft to apply a preliminary expansion force to the retention subassembly to initially engage the retention subassembly with the lifting tabs prior to application of the lifting force.

22. The device of claim 211 wherein the biasing device comprises one of a spring positioned around the shaft, a pneumatic piston integrally formed with the shaft, and a hydraulic piston integrally formed with the shaft.

23. The device of claim 20, wherein each of the vertex joint, the lift joint and the lever joints include a dielectric bushing and washer assembly to electrically isolate each of the legs, and the cross-arms from each other.

24. The device of claim 20, wherein the shaft is pivotally joined with the cross-arms at the lift joint such that a lifting force applied to the shaft causes the distal ends of the cross-arms to apply an expansion force to the legs to expand the retention subassembly when the tab catches are engaged with the battery tabs, thereby firmly engaging the tab catches with battery lifting tabs until the lifting force is removed.

25. The device of claim 20, wherein the device further comprises a stop tube positioned around the shaft to limit expansion of the retention subassembly when the lifting force is applied.

26. The device of claim 20, wherein the handle comprises at least one of a lift receptacle structured to receive a hooking device of a battery hoist to apply the lifting force to the shaft, and a lift bar having opposing arms that extend outwardly from opposing side of the shaft such that the lift bar arms can be manually grasped to apply lifting force to the shaft.
